(19) United States
(12) Patent Application Publication
(10) Pub. No.: US 2008/0059999 A1
(43) Pub. Date: Mar. 6, 2008

(54) Multi-function display controller

(76) Inventors: John Winans, Glen Ellyn, IL (US); John Malec, Chicago, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/511,618

(22) Filed: Aug. 29, 2006

(51) Int. Cl. H04N 7/10

(52) U.S. Cl. 725/34

(57) ABSTRACT

Methods and arrangements for signal substitution by set-top-boxes in response to event triggers conveyed by channels outside standard audio/video streams.

### FIELD OF THE INVENTION

The present invention relates to methods and apparatus for presenting selected regular and alternative video signals to a display device.

### BACKGROUND

Display devices such as televisions have long been capable of receiving numerous video input signals and selecting one from among the received signals for presentation on the display device. The selection has historically been performed by a video viewer. Systems have been developed in which a plurality of video input signals are received at a display device or an adjunct to the display device and the selection of which video is to be presented is made on the basis of control signals received over the communication medium e.g., cable, conveying the input signals. Such systems have been used to substitute alternative video information to users selected by a presenter of information. The known systems are constrained and do not allow a great deal of versatility and control.

The present method and apparatus provide a broad range of services including signal substitution to be provided at separate display units. The system is connected to exchange information with the internet and various additional types of A/V and control equipment. Signal substitution is performed in response to event triggers transmitted from a broadcast facility over the internet to set-top-boxes provided by a service provider. The set-top-boxes respond to the event triggers received out of video band over the internet by performing substitution for “broadcast” video received in band from, for example, cable or satellite. The set-top-boxes communicate over the internet to obtain substitute display material and to also obtain information to provide services and features not relating to video presented by a broadcast facility. Further, by connection to the internet wireless services such as text messaging and cell phones can interact with audio visual material presented on a display.

### BRIEF DESCRIPTION OF THE DRAWINGS

FIG. 1 is a general block diagram of a service providing system;

FIG. 2 is a block diagram of a set-top-box shown in FIG. 1;

FIG. 3 is a block diagram of an operational system including multiple broadcast distribution systems; and

FIG. 4 is a confined block and flow diagram of the distribution of event triggers.

### DESCRIPTION

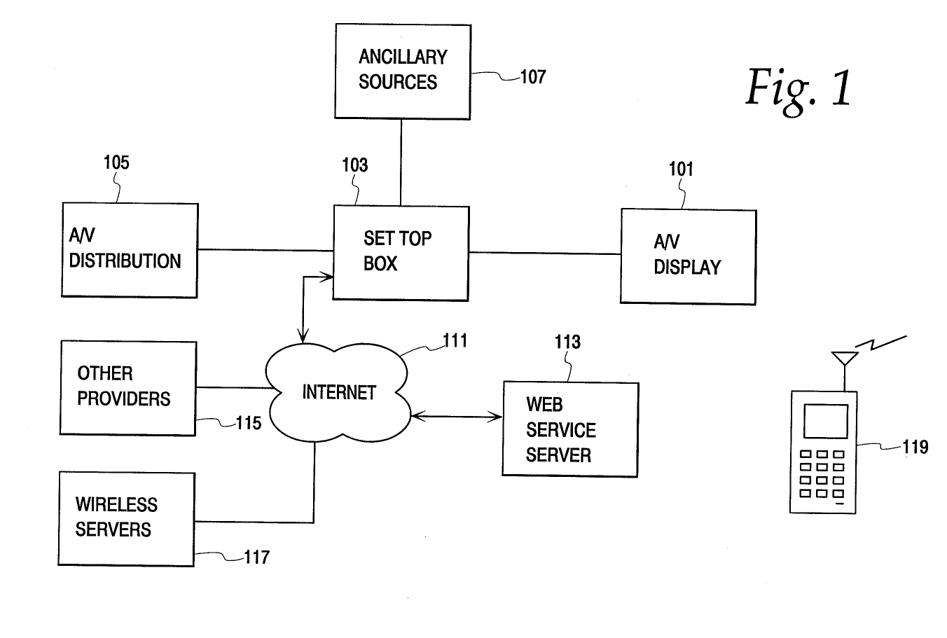

The present system includes methods and apparatus for controlling the presentation of audio and video information (A/V information) to individuals at an A/V Display. FIG. 1 is a generalized block diagram of the system which includes an A/V Display 101 for presentation of information to viewers. A/V Display 101 receives A/V signals from a set-top-box 103 which in turn receives standard A/V signals from an A/V distribution system 105. The Distribution system 105 is largely the A/V signal providing universe we know of today which may include cable TV, Satellite TV, CCTV and over-the-air broadcasting. Accordingly, the set-top-box 103 has a large number of regular A/V signals to select from for presentation on A/V display 101.

When the standard A/V signals are to be displayed, a viewer may exercise control over the set-top-box and the A/V display in much the same way that a cable TV or Satellite TV viewer operates his or her TV system. Set-top-box 103 has additional capabilities. For example, ancillary sources of A/V information 107 such as sound microphones and video cameras may be connected as signal inputs to the set-top-box 103 and selected for presentation.

Set-top-box 103 is also used to insert substitute programming into the video stream being sent to the Display 101. For example, by agreement with the standard video providers, an advertisement for dietary supplements might be substituted for an advertisement for snack foods in an exercise establishment. In order to perform such substitution the set-top-box must have access to the substitute A/V signal and it must be informed where and when to play the substitute A/V signal. One source of substitute signals is the normal video stream running from the Distribution system 105 to the set-top-box 103. One or more of the video “channels” or “streams” running from the Distribution system 105 may convey substitute A/V signals. Advantageously, these may be recorded within the set-top-box for later play back to the A/V display. Also, the substitute signals may be received at the set-top-box 103 via a network connection 109 which in FIG. 1 is a connection to the Internet 111. With a network connection 109 the substitute signals are transmitted from any compatible source of A/V signals connected to the network. The provider of the signal substitution system made possible by the set-top-box 103 has a network server 113 which can communicate with many set-top-boxes to download substitute signals and to receive substitute signals from other network connected sources. For example, sport and news data feeds may constitute a portion of the other network sources 115 to connect data input signals to the set-top-box 103 and the web service server 113 via the internet.

As an additional base for features, the set-top-box 103 is connected to the cellular telephone and text messaging network via the internet 111 and wireless servers 1 17. A cell phone 119 can then be used, as described below to interact with software programs run on the set-top-box 103 and the A/V signals presented at display device 101.

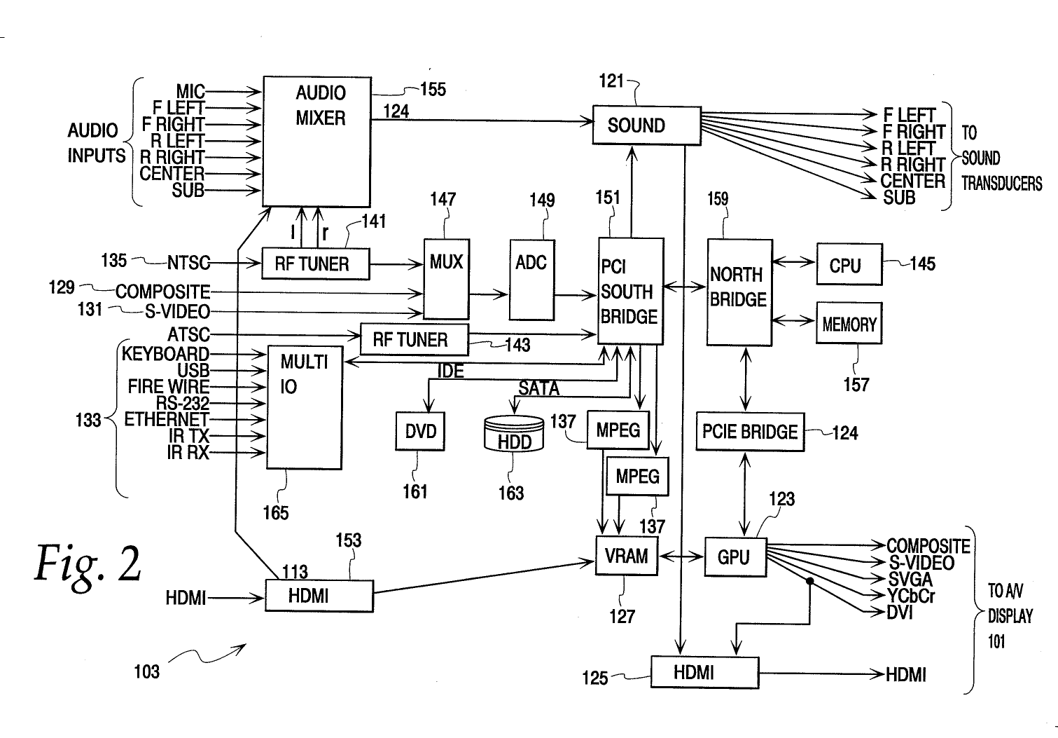

FIG. 2 is a block diagram of a set-top-box 103 which is a highly robust unit capable of receiving a wide variety of A/V and control signals and, in response, presenting selected video to an A/V display 101. The video outputs for the display 101 are grouped with a bracket and labeled “to A/V display”. Similarly, the audio outputs are grouped with a bracket labeled “to sound transducers”. The audio outputs represent 5.1 surround outputs which are produced in a sound processor 121. In other embodiments other types of sound output signals such as monaural and stereo speaker outputs, monaural stereo line outputs and other versions of surround. The video outputs include composite, S-Video, SVGA, YCbCr and DVI which are produced in a graphics processing unit 123. These are selected from and converted in a known manner to a video display 101. The DVI output of the graphics processor 123 may be converted to HDMI by an appropriate HDMI source interface 125 for selective connection to a display 101. The video content, i.e., the video signal to be presented is first accumulated in a video RAM 127 in a manner well known in the art, read by the graphics processor 123 and put in appropriate formats for presentation to the display 101. In addition, the graphics processor 123 may receive digital signals from other parts of the system in order to provide video enhancements such as text or graphics overlays. One such source of digital video signals may be a CPU 145 which controls the set-top-box 103 and communicates with the graphics processor 123 via a north bridge arrangement 159 and a PCI express controller 124.

The set-top-box is capable of receiving a plurality of possible standard video signals from a plurality of different sources such as over the air, Cable TV and Satellite TV. In one embodiment the set-top-box includes one or more receivers, each for one of the major video sources such as cable TV and satellite TV. In a preferred embodiment receivers for these signal sources are provided separately from the set-top-box 103 and connected to the set-top-box by a path for video signals such as DVI or S-Video.

FIG. 2 shows a set-top-box 103 equipped to operate with separate video stream receivers for the major providers such as analog/digital/hybrid cable TV and satellite TV. The set-top-box 103 comprises plurality of A/V signal inputs for connection to the external receivers and includes an rf tuner 141 for NTSC inputs. Analog A/V signals such as the output of rf tuner 141 and composite input signals 129 and S-Video input signals 131 are selected, under the control of a CPU 145, by a multiplex device 147 for application to an analog to digital converter ADC 149. The ADC converts the selected incoming video signal from multiplexor 147, to digital format and applies it as an input to a South PCI bridge 151. Bridge 151 also receives as an input the digital video signals generated by ATSC tuner 143. Set-top-box 103 also receives HDMI audio/video signal inputs at an HDMI convertor 153 and applies the digital outputs directly to RAM 127. The sound portion of signals received at the HDMI convertor 153 is applied to an audio mixer 155 which also receives various other sound inputs as represented at 135 of FIG. 2. The outputs of mixer 155 are applied as inputs to the sound processor 121.

CPU 145 controls the operation of set-top-box 103 in response to programs and data stored in a memory 157. CPU 145 communicates with memory 157 via north PCI bridge 159 which is also connected to exchange information with the south bridge circuit 151 and arrangements connected to it. Through the south bridge circuit 151, CPU 145 also communicates with a DVD device 161, a hard drive 163 and a digital input-output multiplexor 165. An assortment of digital inputs including Keyboard, USB, fire wire, RS-232 and Ethernet, which are represented at 133, are available to exchange information with the set-top-box 103. CPU 145 identifies which of the plurality of possible A/V sources is to be played through to its connected A/V display 101 and controls the involved multiplexor and bridges needed to complete the connection. For example, when a cable receiver output on S-video 131 is to be connected to the display 101, multiplexer 147 is controlled to connect the S-Video input to the south bridge 151 via the ADC 149. The south bridge 151 in turn provides a connection, via one of two MPEG processor P137, VRAM 127 to graphics processor 123 which outputs the video signal to A/V display 101. In the preceding example the communication medium within set-top-box 103 was stated to include PCI bridges such as 151, 159 and 124. Other embodiments may employ other well known arrangements for communicating digital data at high data rates. Additionally, other high speed manipulation devices may be used to provide the functions of MPEG processors.

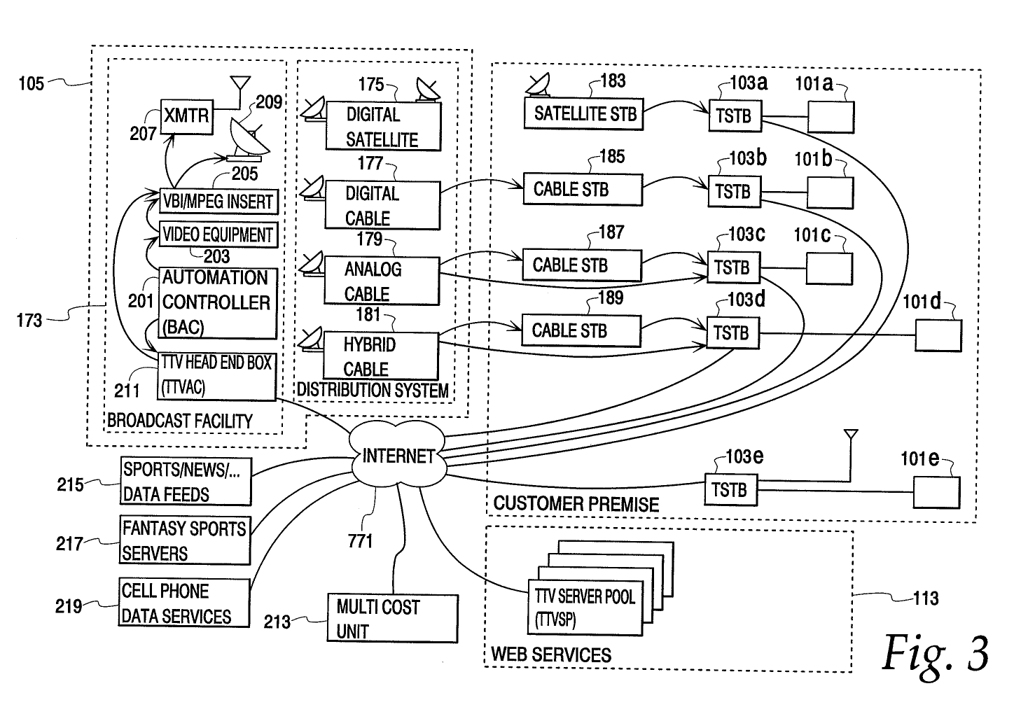

Digital signals for controlling the functions of set-top-box 103 can be received from any of the inputs 133. In the present example, the Ethernet input is connected to exchange control information and data with the internet 171. FIG. 3 represents the connection of a plurality of set-top-boxes 103a-e with the internet 171 and various sources of regular A/V input signals. In FIG. 3 the A/V distribution 105 FIG. 1 is represented by a broadcast facility 173, 3 cable distribution systems 177,179 and 181 and a digital satellite distribution system 175. Each of the distribution systems 175-181 receives A/V signals from a plurality of broadcast facilities such as facility 173 and combines the received signals into an appropriate regular video stream for distribution to its subscribers. The subscribers are represented by a plurality of distribution receivers 183-189 each of which is connected to a set-top-box 103a-e of the type shown in FIG. 2 and discussed above. Each of the set-top-boxes 103a-e is connected to the internet 171 which is in turn connected to the broadcast facility 173 and to the other servers identified previously with regard to FIG. 1.

When a given A/V display e.g.,101a is to display a “channel”, the associated distribution receiver e.g., 183 is set up to select a channel in the well known manner and the set-top-box 103a is controlled to pass the received A/V signal on to its connected display 101a. When the channel is to be changed the distribution receiver e.g., 183 is controlled to select a new channel which is passed on to the display 101a by the set-top-box 103a. All of the set-top-boxes are capable of substituting a secondary A/V signal for the regular A/V signal conveyed by its distribution receiver 183-189. To do so the set-top-box must have the appropriate A/V signal for substitution and have the necessary information identifying when the substitution is to occur. In the present example, the substitute video source may be one of the distributed video streams such as provided by distribution receiver 183 or it may be data received over the internet 171. Further, the identification of timing for video substitution is done out-of-band, over for example, the internet 171 and, advantageously, may be sourced by the broadcast facility 173 creating the original video being substituted.

The system of FIG. 3 includes a web service server 113 which stores software programs and substitute video for the various set-top-boxes 103 of the system. The web service server 113 is displayed and maintained by an entity which supplies the set-top-boxes 103 and the services they make available. By common connection to the internet 171 the set-top-boxes 103 can request and download substitute A/V information from the web service server 113. Such downloaded substitute A/V information is received by the set-top-box 103 and stored for example, on the hard drive 163 of that set-top-box along with information identifying the substitute A/V information. The Web service server may also be the provider of software to the set-top-boxes to provide new services and features.

The event triggers which initiate the substitution of video at the set-top-boxes are generated by each broadcast facility 173 producing the A/V programming in which a substitution is to occur. A broadcast facility includes an automation controller or BAC of which BAC 201 is shown in FIG. 3. The BAC 201 responds to data provided by the traffic department of the broadcast facility and identifies a series of video sources such as video tape machines and digital storage which store the A/V signals to be combined into a standard broadcast A/V channel. These various video sources are represented as video equipment 203. The output signals from the video sources 203 are sent in a timely fashion to a video inserter or assembly 205 of a type known in the art which assembles the stream for broadcast by a satellite or over-the-air transmission to a plurality of distribution systems (175-181). The Automation controller 201, in response to the traffic department of the broadcast facility, properly organizes the video portions to make up the stream and properly times when they are sent to the inserter 205.

The automation controller 201 operates by reading a database provided by the traffic department identifying each program segment that is to be assembled and played in real time. Logically, each program segment is recorded on a tape that is in a separate machine. As time approaches to play a particular segment, the automation controller 201 instructs the assigned tape machine to start playing. Exactly how it instructs the machine is known and depends on the type of system provided by the broadcast facility and how it is configured. In general each type of video source machine requires a period of time to start playing and synchronize itself with the rest of the broadcast facility. This is called a “pre-roll” and can take some number of seconds. Accordingly, the automation controller assembles the final video by properly starting the operation of the video sources.

Each broadcast facility includes an event trigger head end 211 which generates and transmits event triggers to the various set-top-boxes 103 to initiate the display of substitute signals as needed. Each event trigger is sent to the set-top-boxes 103 via the internet and identifies the A/V signal into which substitution is to occur and the time of that substitution. The set-top-boxes 103 respond to such event triggers from the event trigger head end 211 by selecting substitute signals from its possible sources and performing substitution needed. The event trigger head end 211 is itself triggered to send event triggers by signals from the automation controller 201 of the broadcast facility. A stimulation signal to the event trigger head end 211 is sent from the automation controller 201 with sufficient “pre-roll” or lead time to permit timely transmission of the event triggers to the set-top-boxes 103.

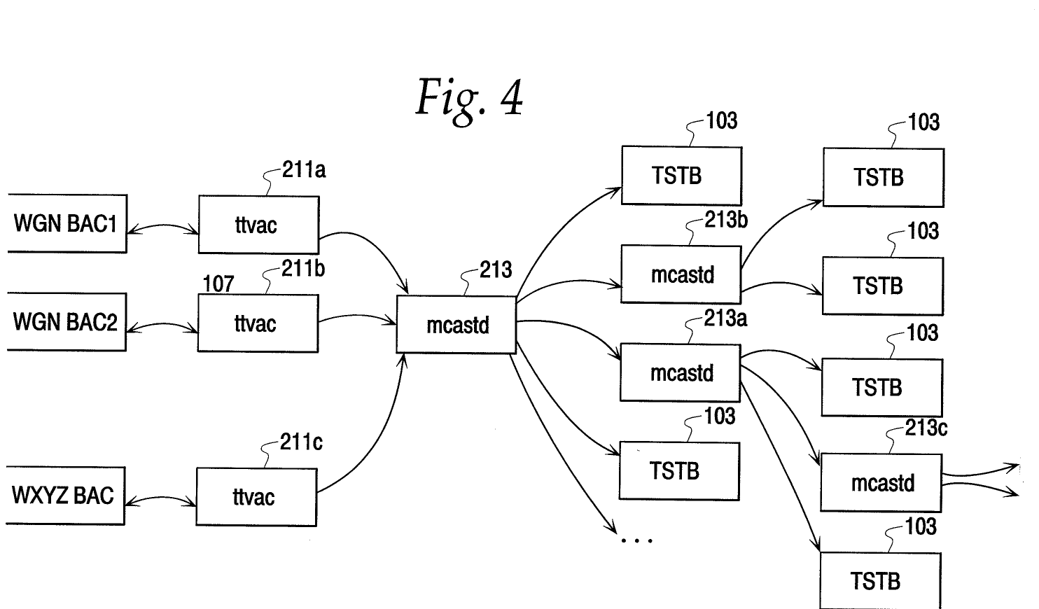

The event triggers from a plurality of broadcast facilities 173 are distributed via the internet to the set-top-boxes 103 of the system as represented in FIG. 4. In order to reduce time delays in deterring the event triggers are sent to a multicast unit 213 where they are replicated and sent via parallel paths to the set-top-boxes and/or other multicast units 213a,b,c. FIG. 4 represents the distribution of event triggers via the internet and multicast units 213. To speed the transmission of the event triggers, the various multicast units 213 may be interconnected via TCP/IP sockets.

The event triggers are sent in the form of who: when: what: id. “Who” is the name of a specific distribution system and broadcaster. For example, “who” may represent Direct TV-CHI-WGN or Comcast-CHI-ESPN1. “When” is a time stamp representing precisely when the substitution operation is to take place. In one embodiment, the time stamp represents Unix-seconds since epoch ‘.’ microseconds. “What” is a command identifying the action to perform. The “what” commands include CUE, PLAY and STOP. “id” is a key representing an application or file upon which an action is to be performed.

The CUE command identifies to a set-top-box that the file identified in the “id” portion will be played in the near future. The PLAY command identifies to the set-top-box 103 that the file identified in “id” is to be played at the specified time. The STOP command specifies that the set-top-box 103 is to stop playing the specified file at an identified time.

Advantageously, the CPU 145 of all set-top-boxes and all of the various event trigger head ends 211 are operating on the basis of the same time such as that provided by the network time protocol NTP. Similarly, all devices could be connected to the National Bureau of Standards time service so that consistent time exists at all units. A given event trigger may be delivered to different set-top-boxes at slightly different times due to different message delays through the internet. Accordingly, the automation controllers initiate the sending of an event trigger sufficiently early so that the event trigger will normally be delivered to all set-top-boxes with sufficient time to respond to the trigger. Should a set-top-box receive a trigger too late to properly respond the set-top-box ignores the event trigger and does not perform the requested action.

The set-top-boxes 103 receive and respond to the event triggers by performing signal substitution or other event. The A/V signal to be provided in substitution will have been requested from the service provider's network server 113 and stored in the set-top-box hard drive163. The substitute signal has a specific id with which an event trigger can identify and access it. Upon receipt of an event trigger the set-top-box must determine whether the event trigger relates to that set-top-box function. Namely whether the set-top-box is presently sending the A/V signal identified in the “who” portion of the event trigger to the display unit. When the set-top-box is, for example, presenting HG-TV to the display unit and the event trigger identifies ESPN1, the event trigger is ignored. In embodiments where the set-top-box 103 is responsible for channel selection, the particular channel being presented to the display is known because it is being controlled by the local CPU 145. In embodiments where the distribution receiver e.g., 183 is separate from the set-top-box 103, the set-top-box must identify the channel being presented by other methods.

The set-top-box identifies the channel being presented to the display so that the system is ready to substitute signals needed. Some broadcast signals, such as NTSC signals include the source identity in a portion of the signal such the vertical blanking interval. Thus, the set-top-box surveys the vertical blanking interval from time to time when such signals are being displayed so that a current reading of the channel being displayed kept. When other types of signals are being received, no such channel identity is conveyed with the signal and the channel must be identified from the signal content. When signal content must be recognized a significant portion of the identification is carried out by methods and apparatus at the Web services server 113. For example, the server 113 may include receivers for each channel in which signal substitution is expected. A predetermined portion of each received signal is periodically sampled and signature data, such as a hash sum, is extracted from the sample. Thus, signature data for each possible channel is created and updated by the Web services server 113. When a set-top-box needs to identify the channel being presented to its associated display, a sample of the predetermined portion of signal is taken by the set-top-box 103 and presented to the web service server 113 along with a request for identification. The web service server 113 then compares the set-top-box sample with the signatures stored at the web services server to identify a match. When the sampled channel is matched a message is returned to the set-top-box to identify the channel. The set-top-box can then store the identity of the regular signal (channel) being presented until a change is detected.

The following is an example of a signal substitution at all set-top-boxes presenting Direct TV Chicago ESPN2. At the appropriate pre-roll time for substitution, automation controller 201 sends to its associated event trigger head end 211 a trigger message which identifies the substitution. The head end 211 generates an event trigger identifying who: when: what: id which is transmitted to the internet 171 and multicast to all set-top-boxes capable of displaying Direct TV-Chicago-ESPN2. The set-top-boxes then receive the trigger and identify whether they are presently display Direct TV Chicago ESPN2. If not, the event trigger is ignored. If Direct TV Chicago ESPN2 is being displayed and the id of the file to be substituted matches information stored in the set-top-box, CPU 145 substitutes the data at id for the standard data being received in band as a part of ESPN2 at the time specified in the event trigger. A stop event trigger may then be sent to terminate the substitution of the end of the file id may cause reversion back to the standard channel signal.

As described above the set-top-boxes 103 and support system provide a capable arrangement for displaying standard or substitute A/V signals on a display device. The capabilities of the set-top-box coupled with the internet communication capability are a vehicle by which additional features and services can be provided. The set-top-box 103 can access A/V signals from DVD 161, hard drive 163 or any of the inputs connected to digital I/O 165 and display those signals to the exclusion of incoming commercial video stream such as Cable TV or Satellite TV. Accordingly, a large number of special programs can be produced and presented. Further, the CPU 145 acting in conjunction with PCI Express Controller 124 and graphics processor 123 can present graphics stored in memory such as memory 157 on the display 101 and present graphics overlays on video from any of the previously discussed video sources. Such graphics might include locally produced and/or locally relevant advertising or games or contests for the enjoyment of the viewers of the display.

The internet connection with the set-top-boxes 103 also enhances the capabilities of the system as a whole. The set-top-box 103 can access via the internet, various services, web pages and data sources and use the information assessed to provide A/VV display information. For example, a connection may be completed to sports news services 215 or to fantasy sports web site server 217 to display accessed information on A/V display 101. Significantly, the set-top-box 103 has internet access to the cell phone/text message network servers 219. Such access allows interactive A/V features to be provided for the viewers. For example, a video camera may be used to present images of “cute couples”. Fellow viewers are then permitted to vote on the cutest by sending wireless text messages of a type defined by overlay graphics on the presented video via the text message network and the results displayed as another overlay.

While there has been illustrated and described particular embodiments of the present invention, it will be appreciated that numerous changes and modifications will occur to those skilled in the art, and it is intended in the appended claims to cover all those changes and modifications which fall within the true scope of the present invention.

What is claimed is:

1. A method of providing substitute video on a display device comprising:
receiving at a display controller standard video signals via a standard video path;
providing selected ones of the standard video signals on the display device;
receiving at the display controller one or more substitute video signals;
receiving from a provider of one or more of the standard video signals, permission to substitute a substitute video signal for a portion of the standard signal;
receiving at the display controller an event trigger identifying the beginning of a substitution, the event trigger being received on a communication path other than the standard video path; and
responsive to the received event trigger sending a substitute video signal to the display device in place of standard video signal.

2. A method in accordance with claim 1 wherein a substitute video signal comprises a scenario and the method comprises storing at the display controller at least a portion of a scenario.

3. A method in accordance with claim 2 comprising storing a plurality of substitute video scenarios in the display controller.

4. A method in accordance with claim 3 comprising selecting by the display controller a substitute video scenario for presentation on the display.

5. A method in accordance with claim 1 comprising synchronizing a clock in the display controller with a clock associated with the event trigger.

6. A method in accordance with claim 5 comprising substituting a standard video signal with a substitute video signal at a time identified by the event trigger.

7. A method in accordance with claim 6 wherein the step of receiving the event trigger comprises receiving the event trigger via the internet.

8. A method in accordance with claim 8 wherein the standard video signals are generated by a video production facility and comprising providing signals corresponding to the event triggers from the production facility.

9. A display controller for controlling video signals presented for display on a display device comprising:
a source of standard video signals conveyed in a video communication path;
a source of first substitute video signals;
a network interface for receiving event triggers conveyed by a digital network;
an apparatus for presenting standard video signals to the display device;
a controller unit responsive to event triggers received by the network interface for presenting first substitute video signals to the display device in substitution for standard video signals.

10. A display controller according to claim 9 wherein the network interface is an internet interface.

11. A display controller according to claim 9 comprising a clock signal source.

12. A display controller according to claim 11 wherein the event triggers identify a time for presentation of first substitute video signals to the display device.

13. A display controller according to claim 12 wherein the source of standard video signals substantially simultaneously provides a plurality of standard video signals.

14. A display controller according to claim 13 comprising apparatus for identifying which of the plurality of standard video signals is being presented to the display device.

15. A display controller according to claim 14 wherein the event triggers identify specific standard video signals which are to be replaced by substitution.

16. A display controller according to claim 9 comprising a source of user originated video signals and apparatus for substituting the user originated video signals for standard video signals.

17. A display controller according to claim 16 comprising a connection to a user controlled video source.

18. A display controller according to claim 17 wherein the user controlled video source comprises a video camera.

19. A display controller according to claim 18 wherein the user controlled video source comprises a DVD player.

20. A display controller according to claim 19 comprising a source of overlay video signals.

21. A display controller according to claim 20 comprising apparatus for combining the overlay video signals with standard video signals before presentation to the display device.

22. A video substitution system for presenting standard video signals and substitute video signals to a display device, comprising:
one or more standard video signal originators, each for presenting one or more standard video signals in a video stream, each video originator comprising:
apparatus for transmitting standard video signals in the video stream;
an automation controller for controlling a plurality of video sources to create the standard video signals;
a substitution controller responsive to signals from the automation controller for transmitting event triggers on a network separate from the video stream; and
a plurality display controllers each comprising:
apparatus for receiving standard video streams from a plurality of standard video originators;
an apparatus for selectively connecting the standard video signals to a display device;
a connection to receive event triggers from the network;
a source of substitution video signals;
a control unit responsive to the received event triggers for presenting substitute video to the display device in place of standard video signal;

23. A video substitution system according to claim 22 wherein each display controller comprises a clock synchronized with a time source of at least one video signal originator and the event triggers identify a time for signal substitution.

24. A video substitution system according to claim 22 wherein the network comprises the internet.

25. A video substitution system according to claim 22 wherein the substitution controller and intermediate nodes of the network cooperate to broadcast event triggers to a plurality of display controllers.

26. A video substitution system according to claim 22 comprising a storage and control unit connected to the network for providing support materials to the plurality of display controllers.

27. A video substitution system according to claim 26 wherein the storage and control unit stores computer programs for use by the display controllers.

28. A video substitution system according to claim 27 wherein the storage and control unit stores source material for substitute video signals.

29. A video substitution system according to claim 28 wherein each display controller comprises arrangements for accessing substitute video signals and computer programs from the storage and control unit via the network.
